(19) United States
(12) Patent Application Publication
(10) Pub. No.: US 2026/0165892 A1
(43) Pub. Date: Jun. 18, 2026

(54) Hub Locking System for Wheelchairs

(71) Applicant: Steven M Ortiz, Gilbert, AZ (US)

(72) Inventor: Steven M Ortiz, Gilbert, AZ (US)

(21) Appl. No.: 19/328,012

(22) Filed: Sep. 12, 2025

Related U.S. Application Data
(60) Provisional application No. 63/694,320, filed on Sep. 13, 2024.

(51) Int. Cl. A61G 5/10

(52) U.S. Cl. CPC A61G 5/1027; A61G 5/1035

(57) ABSTRACT

The disclosed invention is a manual wheelchair locking mechanism with important operational improvements. A shift cable plunger assembly utilizes a locking pin that is modified to make it more reliable to engage with the locking disc. The locking disc is attached to a spoke assembly that is modified to provide improved spoke stability.

### CROSS REFERENCE TO RELATED APPLICATIONS

This application claims the benefit of provisional application 63/694,320 filed on Sep. 13, 2024. This prior application is included by reference herein.

### STATEMENT OF FEDERALLY SPONSORED RESEARCH OR DEVELOPMENT

Not applicable.

### BACKGROUND OF THE INVENTION

### (1) Field of the Invention

This invention is directed to equipment for wheelchairs, in particular the locking mechanism for at least one wheel. It is an important safety feature to ensure that the wheelchair is stable when a wheelchair user is transferring on and off of it.

### (2) Description of Related Art

A manual wheelchair is usually a four wheel mobility device that is maneuvered by the user/caregiver without the need for external power. It comprises a frame, seat, back support, rear wheels, front caster wheels, and foot supports. Manual wheelchairs provide mobility for individuals with limited or impaired mobility.

Currently, a wheelchair locking mechanism for a manual wheelchair is often a simple lever that utilizes a pressure bar that is pressed against the outside of the wheel. The lever is small and simple; and usually placed where the wheelchair occupant can operate it.

A more advanced wheel locking assembly is to add a disc brake and a cable system where a lever will move brake pads against the disc. The handle or brake pads are locked into position by the handle design or the brake pad design.

Another variant is to put holes in the disc and use a cable activated pin is pushed through a locking hole.

However, this latter development has problems that are not addressed.
1. Locking pins have trouble engaging into the hole, sometimes due to tolerances. The locking pin/hole design fails to have the high level of reliability needed for patients with limited mobility. A loose tolerance will enable an easier fit but will allow wheel movement that will disturb a wheelchair user.
2. Current designs typically incorporate a locking disc secured to the wheel's tire spokes, with a poor design that allows spoke bending. There are unsolved problems with this design due to the spoke attachment shifting within the plastic, causing wheel motion to put added stress on the wheel spokes. The additional spoke stress from a minor sudden stop, eventually causes the spokes to bend at the connection to the hub, causing locking pin failures. This difficulty must be corrected for the locking pin method to be reliable.

For example, U.S. Pat. No. 6,341,671 by Ebersole utilizes a lever without tactile feedback when engaging the breaking lock system, has an over complicated brake mechanism, and is unsuitable for a wheelchair with a tire-spoke system.

U.S. Pat. No. 7,252,300 by Hargroder and US 20220280363 by Braun have similar problems.

Previous wheelchair designs have not adequately addressed the need for a high level of wheelchair lock reliability, the certainty of the lock handle position, prevention of damage to a wheel chair utilizing a spoke design, and tolerance for minor misalignments in the pin/lock hole position, highlight the need for a design providing desirable improvements.

### BRIEF STATEMENT OF THE INVENTION

The disclosed invention is a manual wheelchair locking mechanism with important operational improvements. A shift cable plunger assembly utilizes a locking pin that is modified to make it more reliable to engage with the locking disc. The locking disc is attached to a spoke assembly that is modified to provide improved spoke stability.

### BRIEF DESCRIPTION OF THE FIGURES

FIG. 1 shows the main components of the manual wheelchair locking mechanism.

FIG. 2 shows the handle used to activate the locking mechanism.

FIG. 3 shows an exploded view of the handle assembly components.

FIGS. 4A,4B show an exploded view of the plunger assembly.

FIG. 5 shows an exploded view of the locking disc.

FIG. 6 shows the assembled locking disc with wheelchair spokes.

FIGS. 7A-7B show the handle rotation.

### DETAILED DESCRIPTION OF THE INVENTION

Labels used in the figures.
101 Handle Assembly
102a,b Disc lock
103a,b Pin Plunger Assembly
104a,b Push-Pull Control Cable with Casing
301 Aluminum Handle Main
302 Aluminum Frame Mount
303 button head hex screw
304 Sintered Bronze Bushing
305 button head hex screw
306 Aluminum Slide
307a,b Sintered bronze bushing
308 countersink hex screw
309 Aluminum Cable Slide
310 Bronze sleeve bearing
311 Threaded Standoff
312 Aluminum Cable Hold
313 Socket Head
314 Aluminum Handle
315 Bronze bearing
316 Threaded Standoff
401 Aluminum Threaded Cap
402 Spring
403 Threaded Sleeve ¾″-16
404 Steel Plunger
405 Cable Terminating Slot
406 Cable End
501 Aluminum Slotted Disc
502 Urethane Molded Disc Ring
503 Urethane Molded Disc Ring
504a,b Aluminum Half Disc
505 Screws
506 Slots
601 Wheelchair Spokes
602 Spoke End Gripping Between Urethane Rings.
701 Aluminum Wires
702 Handle Contour

The hub locking system is designed for manual wheelchairs. The system utilizes a single lever to lock both wheels in place without relying on tire contact. This avoids user worry due to the tires experiencing treadwear, tire pressure failure, or the need adjust/re-align the locking mechanism. When a wheelchair user sits, it is important that the rear wheels on the wheelchair do not move. If the rear wheels on the wheelchair move, the user can experience a slow or hard fall.

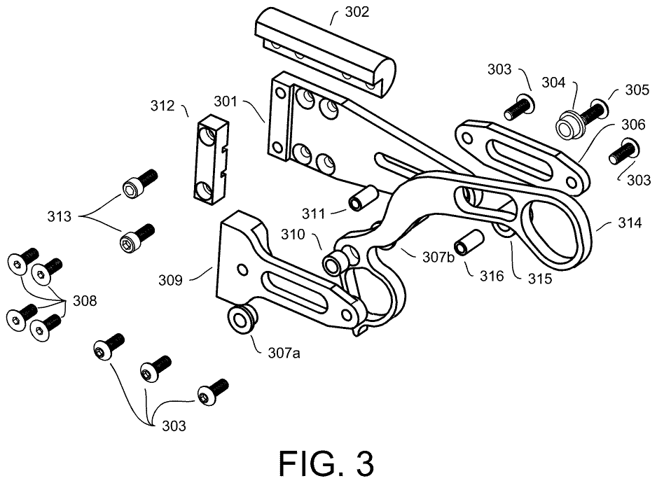

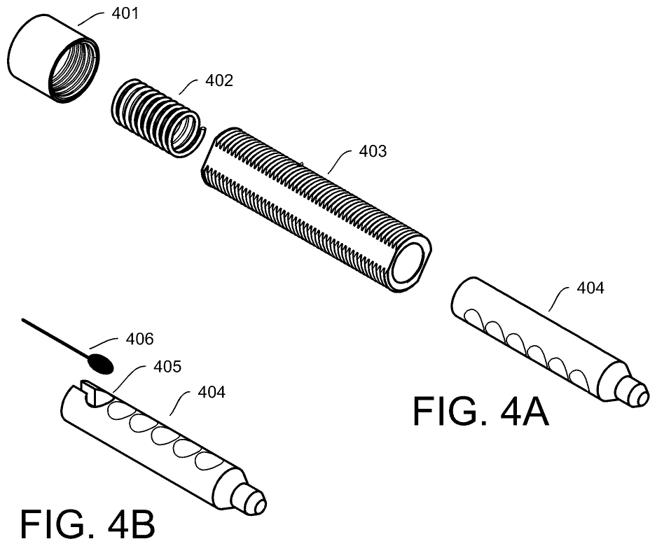

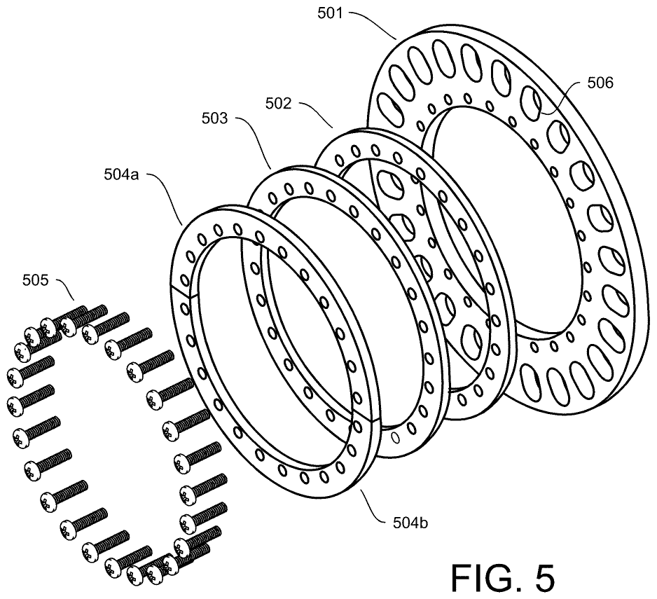

The highlighted design features are the handle assembly FIG. 3, and the disc hub assembly of FIG. 5, and the plunger assembly of FIGS. 4A-B.

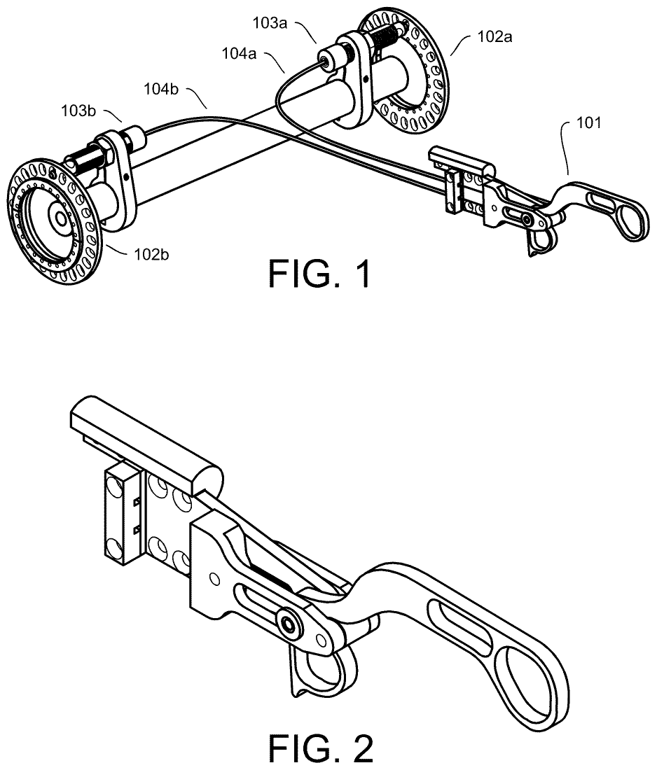

In FIG. 1, the overall design is shown. The handle assembly 101 is connected to the locking discs pin plunger assemblies 103a,b by use of a bicycle shifting cable 104a,b with an outer casing. A pin from each pin plunger assembly is then pushed into the disc lock 102a,b to prevent wheel movement.

FIG. 2 shows the assembled handle. From the position shown, the handle is pulled upwardly to release the lock, downwardly to engage the locking pin into the disc locks 102a,b. The handle is designed for a two-position movement, and locks into place at each position. In a preferred embodiment, the handle assembly is made from high grade 6061 aluminum components and utilizes bronze bearings and bushings for smooth operation.

FIG. 3 shows the handle assembly. The handle 314 is connected to a bronze sheeve bearing 308 which is held in place by a threaded standoff 311 connected to a bronze bushing 307a,b. Screws connected the parts together. This allows the handle to pivot based on the slot length in the aluminum cable slide 309 which is connected to the aluminum slide 306. The cable slider 309 is connected to handle bracket 301, which is connected to the frame mount 302. The frame mount 302 is attached to the wheelchair frame by welding, screws, or clamping. A cable holder 312 is connected to the handle bracket and holds outer casing fixed to the handle bracket. The connection provides a secure clamp to ensure the bicycle shift cable properly slides inside the casing. Various screws connect the assembly such as hex screws 303, 305, 308, socket head screws 313, and bushings 304, 307a,b, 310, 315 as illustrated.

In FIG. 3 the handle 314 rotates with the screw 305 as the pivot point. When handle 314 rotates in either direction (up and back/forward and down), it rolls against bronze bearing 315 which is attached to aluminum slide 306 and the cable slide 309 with the screw 303, standoff 316 and another standoff 311. The slide 306 and the cable slide 309 slide either forward or backwards when the handle 314 is rotated. This is the mechanism that pulls or releases the shift cables (control cables) to disengage or engage the plungers in the slotted discs.

FIG. 4A, B show the pin plunger assembly which comprises an end cap 401, a spring 402, a threaded sleeve 403, and a steel plunger 404 (locking pin). The shifting cable 406 is inserted into the cable terminating slot 405 to provide a connection to the handle movement. The steel plunger has additional holes drilled into it to reduce weight.

The spring 402 provides a default operation where the locking pin will always be engaged in the locking disc. Also, the use of a shifting cable is more reliable than a hydraulic system as the fit tolerance for the plunger is less important. Simple lubrication is needed to ensure the plunger easily moves within the threaded sleeve.

FIG. 5 shows the locking disc assembly includes an aluminum slotted disc 501 where the slots 506 are used by the locking pin 404. Urethane molded disc rings 502, 503 are compressed by the half disc rings 504a,b against the slotted disc 501 by using screws 505. The two molded rings provide a place for the wheel spokes which are embedded/compressed between the two rings. In a preferred embodiment, the slotted disc hub assembly is designed to be used with typical wheels having hubs not exceeding 2 ¾″ in diameter. The slotted disc is preferably made from high grade 7075 aluminum and is held in place with custom made urethane rings along with 7075 aluminum half discs to prevent spoke damage, while keeping the slotted disc solidly in place.

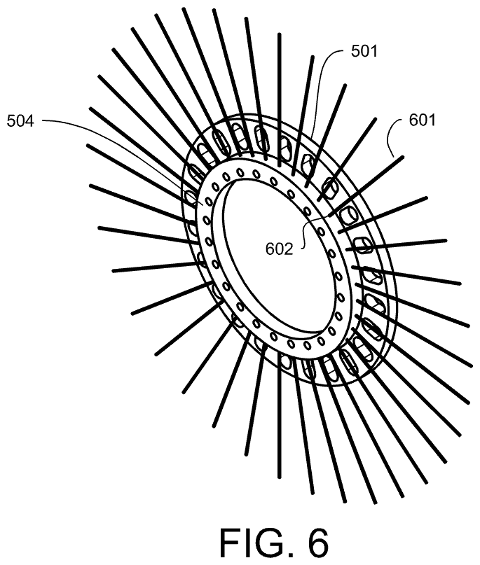

FIG. 6 shows the wheel spokes 601 having one end 602 embedded into the urethane discs. Current designs have ends are bent or curled to have a firm connection to the locking disc assembly when the urethane discs are squeezed together. If the end is not rigidly connected, the spokes will partially slide out. If that happens, any mild movement of the wheelchair during locking will cause the spokes to bend/twist, lowering the amount of weight the wheelchair will support.

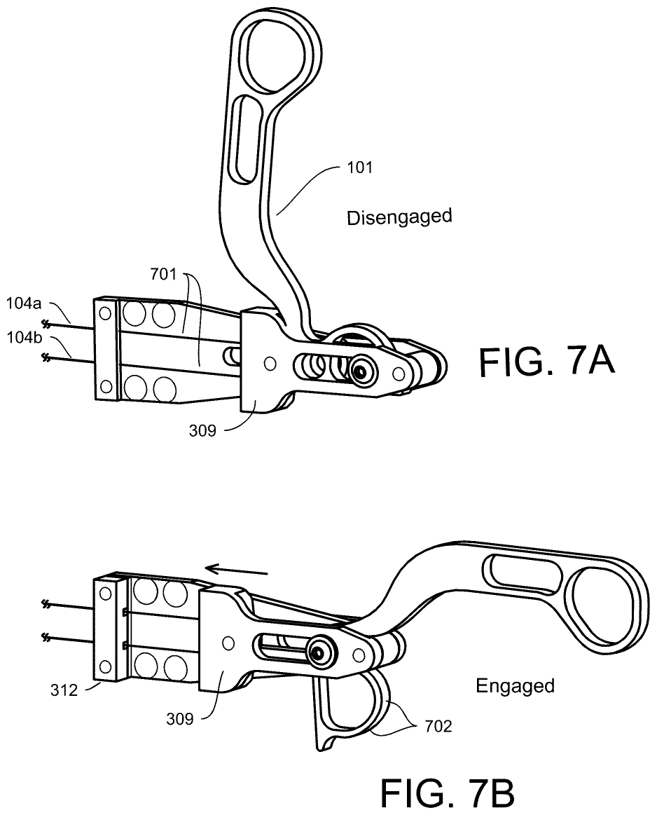

FIGS. 7A-7B show the handle 101 rotation that moves the lock pins in and out. When the handle is rotated, the aluminum wires 701 inside the Control Cables 104a,b are moved. The handle contour 702 moves the steel plungers in and out by moving the aluminum cable slide 309 and the aluminum slide 306. The handle contour also facilitates a two-position locking for the in and out plunger positions for the vertical (FIG. 7A) or horizontal (FIG. 7B) orientations. Plungers springs provide engagement against a slot in the 301 aluminum handle main,

When the handle is in the engaged position, it is at rest at the bottom of the handle stroke. When it is rotated to dis-engage the plunger pin end, the bronze sleeve bearing 310 slides across the slot in the aluminum handle main 301. This retracts the aluminum cable slider 309 and the aluminum slide 306, which then pulls the aluminum wires 701 and retracts the steel plunger 404. When the user rotates the handle to the up position, they will feel almost a click when the lock is fully dis-engaged.

The locking disc assembly is superior to the prior art because the stress that the spokes receive is greatly reduced due to the urethane ring design. Prior art disc assemblies do not have cushioning to absorb the force that the wheelchair user inflicts on the locking system, as they are made of only aluminum or plastic components. In contrast, the disclosed urethane rings absorb the force before damaging the spokes, thus decreasing any unnecessary repairs or replacement of the factory wheel assemblies.

Preferably, the handle assembly is made from high grade 6061 aluminum components and utilizes bronze bearings and bushings for smooth operation.

The locking disc assembly is designed to be used with all wheels available on the market with hubs not exceeding 2 ¾″ in diameter. The slotted disc is preferably made from high grade 7075 aluminum and is held in place by the custom-made urethane rings along with 7075 aluminum half discs to prevent spoke damage and keep the locking disc assembly solidly in place.

The plunger assembly is preferably made from 17-4 steel and the locking pin (plunger) is machined with a diameter step down to ensure the pin end will easily slide into a slot. The plungers are also drilled for weight reduction without compromising its strength.

All the designed features and materials improve this design over other hub locks on the market.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. An improved hub locking system for a wheelchair comprising:
A) a handle movable between two positions, said handle is connected to a shift cable,
B) said shift cable being connected to a pair of plunger assemblies, each said plunger assembly further comprising:
a) a plunger with a pin end and a spring end,
b) a spring positioned adjacent to said spring end,
c) said plunger positioned inside a threaded sleeve, and
d) a threaded cap attached to said threaded sleeve encompassing said spring,
C) each said plunger assembly connected to a wheel lock assembly further comprising:
a) a slotted disc with multiple slots to receive said pin end,
b) two urethane discs positioned on either side of said slotted disc,
c) a pair of half discs positioned adjacent to said urethane discs,
d) said slotted disc, said urethane discs, and said half discs are axially aligned and connected together by screws,
D) said handle operable to move said pin ends to be inserted into said slotted discs and be withdrawn from said slotted discs,
E) whereby said handle is operable to prevent movement of said wheelchair.

2. The hub locking system according to claim 1, wherein a plurality of wheelchair spokes having proximal ends positioned between said urethane discs.

3. The hub locking system according to claim 1, wherein a contour on said handle provides a two-position lock.

4. The hub locking system according to claim 1, wherein said handle is rotated to cause a cable slide plate to move horizontally against a fixed plate.

5. The hub locking system according to claim 4, wherein said handle rolls against a bearing attached to an aluminum slide plate that is attached to said cable slide plate.

6. A method for locking wheelchair wheels, comprising:
A) moving a handle between two positions, said handle being connected to a shift cable,
B) said shift cable being connected to a pair of plunger assemblies, each said plunger assembly comprising:
a) a plunger with a pin end and a spring end,
b) a spring positioned adjacent to said spring end,
c) positioning said plunger inside a threaded sleeve,
d) attaching a threaded cap to said threaded sleeve, encompassing said spring,
C) connecting each plunger assembly to a wheel lock assembly, each said wheel lock assembly further comprising:
a) a slotted disc with multiple slots to receive said pin end,
b) two urethane discs,
c) a pair of half discs,
d) axially aligning and connecting said slotted disc, urethane discs, and half discs by screws,
D) operating said handle to move said pin ends to be inserted into said slotted discs and withdrawn from said slotted discs,
E) operating said handle to prevent movement of said wheelchair.

7. The method according to claim 6, wherein a plurality of wheelchair spokes having proximal ends positioned between said urethane discs.

8. The method according to claim 6, wherein a contour on said handle provides a two-position lock.

9. The method according to claim 6, wherein said handle is rotated to cause a cable slide plate to move horizontally against a fixed plate.

10. The method according to claim 9, wherein said handle rolls against a bearing attached to an aluminum slide plate that is attached to said cable slide plate.
